(19) United States
(12) Patent Application Publication
(10) Pub. No.: US 2011/0000325 A1
(43) Pub. Date: Jan. 6, 2011

(54) Linear to Dynamic Power Multiplying Device by Motor Lever

(76) Inventor: Serafim Félix Da Silva, Alagoas (BR)

Correspondence Address: RICHARD M. GOLDBERG, 25 EAST SALEM STREET, SUITE 419, HACKENSACK, NJ, 07601, US

(21) Appl. No.: 12/918,841

(22) PCT Filed: Feb. 13, 2009
(86) PCT No.: PCT/BR2009/000038

§ 371 Date: Aug. 23, 2010

(30) Foreign Application Priority Data
Feb. 22, 2008 (BR) PI0800412-9

(51) Int. Cl. F16H 21/40

(52) U.S. Cl. 74/25

(57) ABSTRACT

Linear to dynamic power multiplying device by motor lever, consisting of a motor (6) that turns a disk (3) driving a lever (5) that drives a gear (2) turning a ratchet (1) and the shaft (8), thus forming a support point on the shaft (9), multiplying the linear power of the lever (5) for dynamic shaft movement (8).

This invention refers to linear to dynamic power multiplying device by motor lever that when combined with more stages of the same device will provide more continuity and power for the final revolution of its shaft. This device is under evolution with a series of improvements by the same inventor who already filed PI 0504162-7 on Sep. 23, 2005 and is the only one that presents countless utilities in the field of modern mechanics, because it makes power application easier in several equipment parts that need rotation command with pitch accuracy, dynamic continuous movement accuracy for automatic machine feeders, belt conveyor drives and various uses in the construction of automatic machines and accurate reducers.

This is a new equipment that uses linear power for transforming into dynamic power, currently, there is no similar equipment.

In the drawings that are attached as part of this report,

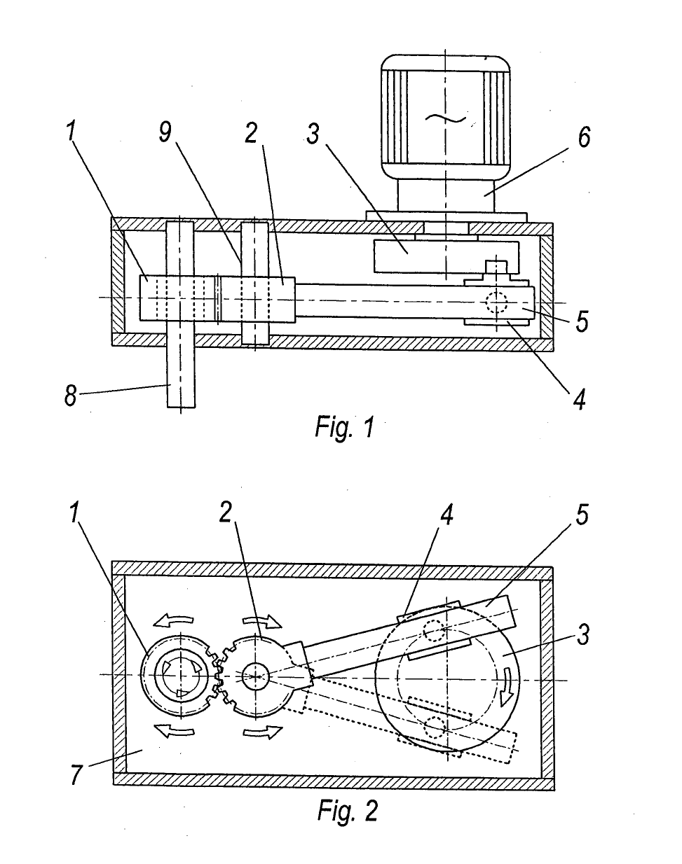

FIG. 1 is an upper view of the invention and

FIG. 2 is a side view of the equipment. As inferred from the drawings, the device object of this invention, uses a ratchet (1) coupled with a gear (2), which in its turn is connected to a lever (5) linked to a bearing (4), providing linear power with the disk rotation (3) connected to a motor (6), thus reducing friction.

The motor (6) turns the disk (3) in the desired direction, displacing the lever (5) in a single direction, the latter (5) making an up and down movement together with the bearing (4), which makes a linear movement on the lever (5) forward and backward, this moving the shaft with a gear (2) also up and down following the displacement of the lever (5). When the lever (5) goes down, it drives the shaft rotation (8), with the ratchet (1), when the lever goes up, it returns free from the ratchet (1), once again in the upper position, so repeating the rotations, the movements become continuous, which are multiplied by the lever power (5) supported on the shaft (9), transmitting its power to the ratchet (1) and to the shaft (8) with as many stages as are needed. Efficiency will be better and smoother the higher is the number of stages, depending on the application.

The linear to dynamic power multiplying device by motor lever, will have a very dynamic range of industrial use in several fields of the mechanical industry in general.

1. LINEAR TO DYNAMIC POWER MULTIPLYING DEVICE BY MOTOR LEVER, consisting of comprising:
a ratchet mounted on a shaft,
a gear that rotates the ratchet and the shaft,
a lever that drives the gear,
a disk that drives the lever, and
a motor that turns the disk.

2. LINEAR TO DYNAMIC POWER MULTIPLYING DEVICE BY MOTOR LEVER, in accordance with claim 1, further comprising a bearing which connects the shaft to the disk in order to aid in moving the shaft with the ratchet.

3. LINEAR TO DYNAMIC POWER MULTIPLYING DEVICE BY MOTOR LEVER, in accordance with claim 2, wherein the bearing moving up due to rotation of the disk will have its weight offset by free return of the ratchet.

4. LINEAR TO DYNAMIC POWER MULTIPLYING DEVICE BY MOTOR LEVER, in accordance with claim 2, wherein the lever is slidably mounted in the bearing in linearly forward and backward directions.

5. LINEAR TO DYNAMIC POWER MULTIPLYING DEVICE BY MOTOR LEVER, in accordance with claim 1, wherein the lever is attached to the gear.

6. LINEAR TO DYNAMIC POWER MULTIPLYING DEVICE BY MOTOR LEVER, in accordance with claim 1, wherein the ratchet and the gear are driven in alternate and opposite directions such that the shaft moves in a single direction.
